(19) United States
(12) Patent Application Publication
(10) Pub. No.: US 2017/0234264 A1
(43) Pub. Date: Aug. 17, 2017

(54) Coating for Components of Internal Combustion Engines

(71) Applicant: KS Kolbenschmidt GmbH, Neckarsulm (DE)

(72) Inventors: Wolfgang Hanke, Nordheim (DE); Leander Schramm, Remda-Teichel (DE)

(73) Assignee: KS Koblenschidmt GmbH, Neckarsulm (DE)

(21) Appl. No.: 15/519,660

(22) PCT Filed: Oct. 16, 2015
(86) PCT No.: PCT/EP2015/074064

§ 371 Date: Apr. 17, 2017

(30) Foreign Application Priority Data
Oct. 17, 2014 (DE) 10 2014 115 176.3

(51) Int. Cl. F02F 3/10; C23C 4/131; F02F 1/00; C23C 4/06

(52) U.S. Cl. CPC F02F 3/10; C23C 4/06; C23C 4/131; F02F 1/004

(57) ABSTRACT

A coating for components of internal combustion engines, in particular for cylinder and/or piston surfaces that includes chromium with a mass fraction between 1 and 30%, iron with a mass fraction between 0 and 50%, carbides and/or oxides with a mass fraction between 0 and 50%, and a solid lubricant with a mass fraction between 0 and 30%.

### CROSS-REFERENCE TO RELATED APPLICATION(S)

This application is a US National stage entry of PCT/EP2015/074064 filed Oct. 16, 2015 which claims priority to DE102014115176.3 filed Oct. 17, 2014.

### TECHNICAL FIELD

This disclosure relates to a coating for components of internal combustion engines. In particular, this invention pertains to coatings for cylinder and/or piston surfaces.

### BACKGROUND

Coating compositions for components of internal combustion engines, in particular for cylinder and/or piston surfaces have been employed, for example, as a corrosion- and wear-resistant cylinder surface for low friction applications in internal combustion engines. These corrosion-resistant and wear-resistant cylinder surfaces for low friction in internal combustion engines are, in turn, particularly suitable for use in diesel engines.

There is a need to reduce transitional friction to achieve lower fuel consumption and to increase wear resistance and corrosion resistance, particularly to exhaust gas recirculation and poor fuel condensates for diesel engines commencing with the Euro 6 emission standards.

Application of a plasma coating containing a powder of composed of different chromium, molybdenum and solid materials to components for internal combustion engines is known from the prior art. A plasma coating of this kind has been applied, for example, to stainless steel cylinders.

An object of the invention is, therefore, to provide an improved, corrosion- and wear-resistant cylinder surface for low friction in internal combustion engines.

### SUMMARY

Disclosed herein is a coating for components of internal combustion engines, in particular for cylinder and/or piston surfaces that includes chromium with a mass fraction between 1 and 30%, iron with a mass fraction between 0 and 50%, carbides and/or oxides with a mass fraction between 0 and 50%, and a solid lubricant with a mass fraction between 0 and 30%.

Also disclosed are automotive components such as cylinders and/or pistons that have at least one surface having a coating composition that includes chromium with a mass fraction between 1 and 30%, iron with a mass fraction between 0 and 50%, carbides and/or oxides with a mass fraction between 0 and 50%, and a solid lubricant with a mass fraction between 0 and 30%. Without being bound to any theory, it is believed that the chromium fraction increases the wear resistance and corrosion resistance of the coating. The coating in accordance with the invention results in an improvement in exhaust gas properties and in a reduction in fuel consumption.

These and other aspects of the present disclosure are disclosed in the following detailed description of the embodiments, the appended claims.

### DETAILED DESCRIPTION

An object of the invention as set forth herein is, therefore, to provide an improved, corrosion- and wear-resistant cylinder surface for low friction in internal combustion engines.

Disclosed herein is a coating for components of internal combustion engines, in particular for cylinder and/or piston surfaces. The coating comprises chromium present in a mass fraction between 1 and 30% In certain embodiments, the chromium component can be present in a mass fraction between 5 and 20% while in certain embodiments, the chromium can be present in a mass fraction of 11%. The coating as disclosed herein also comprises iron present the coating composition in a mass fraction between 0 and 50%. In certain embodiments, the iron component can be present in a mass fraction between 15 and 35% while in other embodiments, the iron component can be present in a mass fraction of 25%. The coating composition can also contain carbides and/or oxides present in a mass fraction between 0 and 50%. In certain embodiments, the mass fraction of the carbide and/or oxide component is between 15 and 35%, while in other embodiments, the component will be present as 25% mass ratio. The coating as disclosed herein also comprises a solid lubricant present in a mass fraction between 0 and 30% in certain embodiments. It is also contemplated that, in certain embodiments, the solid lubricant can be present in the coating composition in a mass fraction between 5 and 15%. In certain embodiments, the lubricant component can be present in the coating composition in a mass fraction of 10%. Without being bound to any theory, it is believed that the chromium fraction present in in the coating composition increases the wear resistance and corrosion resistance of the coating. The coating, in accordance with this disclosure, results in an improvement in exhaust gas properties and in a reduction in fuel consumption.

In certain embodiments, it is contemplated that the oxides present in the composition can be aluminum oxide and/or zirconium oxide. Without being bound to any theory, it is believed that coating compositions that include the oxide material present as disclosed herein can xides result in an improvement in the wear resistance of associated components of internal combustion engines, in particular of cylinder and/or piston surfaces.

In certain embodiments, the carbides can be chromium carbide and/or boron carbide. Without being bound to any theory, it is believed that inclusion of carbide compounds in the composition as disclosed herein can result in an improvement in the wear resistance of components of internal combustion engines so treated, in particular of cylinder and/or piston surfaces that have the coating composition on their respective surfaces

It is within the purview of this disclosure that the solid lubricant least one or more of the following: be molybdenum disulfide, tungsten disulfide and/or iron oxide. Without being bound to any theory, it is believed that the solid lubricant material present in the composition can result in an improvement in the sliding friction of components of internal combustion engines, in particular of cylinder and/or piston surfaces.

The coating composition as disclosed herein when applied can have pores. It is believed that the coating porosity can in an improvement in the sliding friction of components of internal combustion engines, in particular of cylinder and/or piston surfaces, at least in part, by taking up lubricants from the lubricant circulating in the internal combustion engine. Pores form a reservoir for lubricant during operation of the internal combustion engine. In this way, the risk of insufficient lubrication between the piston and cylinder wall is substantially decreased. The risk of failure of the internal combustion engine that is fitted with components having the coating under the invention is reduced.

In the coating composition as disclosed the pores can have a pore surface greater than 1,000 μm² with pose sizes between between 250 and 1,500 μm² in certain embodiments and pore sizes between 500 μm² and 1,000 μm² in some embodiments Pore surface is a measure of the contact points between the lubricant stored in the pores and the respective friction body.

The pores can have an average pore volume between 1,000 and 60,000 μm³. in certain embodiments, the pores can have a pore volume between 2,000 and 40,000 μm³. In certain embodiments, the pores can have a pore volume that is between 6,000 and 10,000 μm³. Pore volume defines the ability of the surface of the coating to absorb lubricant.

The coating composition can be one that as applied can have a peak surface roughness less than 0.30. In certain embodiments, the peak surface roughness will be less than 0.20 while in some embodiments, the peak surface roughness will of the applied coating compositions will be less than 0.10.

It is also contemplated that the coating to have a core surface roughness less than 0.40. In certain embodiments, the core surface roughness can be less than 0.30, while in certain embodiments, the certain embodiments, the core surface roughness can be less than 0.20. It is believed that the enhanced surface smoothness achieved by the coating composition disclosed herein can result in reduced friction between the friction bodies. Low friction between piston and cylinder results in fuel savings during operation of the internal combustion engine.

Also disclosed is at least one corrosion-resistant and wear-resistant component such as a corrosion- and wear-resistant cylinder surface and/or surface of a piston for internal combustion engines for low friction, achieved through a wire spraying process with a chromium content in the region of 1% to 30%, with a wire spraying process with a chromium content between 9% to 13%. In certain embodiments, the chromium content can be 11%. In each instance, the other solids content will be in total 100%.

A PTWA internal coating facility is suitable for coating cylinder walls. A PTWA coating system is a facility for coating bores having a diameter from 65 to 350 mm. The additional spraying material is delivered in the form of wire. The nozzle unit can consist of a tungsten cathode doped with thorium, an air-cooled copper pilot nozzle and an electrically conductive wire-shaped filler material that is delivered perpendicular to the pilot nozzle. The plasma gas, a mixture of hydrogen and argon, is delivered through bores located in the cathode holder, lying tangentially to the circumference. Due to the position of the cylinder bores, a gas stream is created spinning along the cathode which escapes at high speed through the nozzle. The process is started by a high-voltage discharge that ionizes and dissociates the plasma gas between pilot nozzle and cathode. The plasma thus created flows at high speed through the nozzle mouth and expands along the longitudinal axis of the nozzle. The plasma is transported to the wire filler material being delivered continuously perpendicular to the nozzle, whereby the electrical circuit is completed. Melting and atomization of the wire is affected in two ways. The wire is firstly resistance heated by high currents, for example 65 to 90 amperes. The collision of the plasma with the preheated wire ensures its melting and atomization.

Installations for the thermal coating of a surface are described, for example, in U.S. Pat. No. 6,372,298 B1, U.S. Pat. No. 6,706,993 B1 and WO 2010/112567 A1. Common to the installations mentioned there are: a wire delivery device for delivering a wire to be melted, wherein the wire acts as an electrode; a source for plasma gas to generate a plasma gas stream; a nozzle body with a nozzle opening through which the plasma gas stream is directed as a plasma gas beam to a wire end; and a second electrode that is located in the plasma gas stream before said stream enters the nozzle opening. U.S. Pat. No. 6,610,959 B2 and WO2012/953371 also discuss such devices.

An electric arc forms through the nozzle opening between the two electrodes. The plasma beam emerging from the nozzle opening strikes the end of the wire and, with the electric arc, causes the wire to melt and the melted wire material to be carried away towards the surface to be coated. Secondary air jets are arranged in a ring around the nozzle opening which produce a secondary gas beam that strikes the material melted from the end of the wire and accelerates the movement towards the surface to be coated and effects a secondary atomization of the melted wire material.

Internal combustion engines, or their engine blocks, can be cast from a metal or light metal, such as aluminum, wherein aluminum blocks in particular have an iron or metal layer on their cylinder bores. The metal layer can be sprayed on thermally. In addition to two-wire arc spraying (TWA), HVOF (High-Velocity Oxygen Fuel) spraying and plasma powder spraying, the above mentioned methods are known as plasma wire spraying or also as PTWA (Plasma Transferred Wire Arc). Coating the cylinder bores with the aid of plasma wire spraying, that is with PTWA, is advantageous in that a coating can be produced that has a positive effect on a reduced wear factor, on extended service life for the internal combustion engine with lower oil consumption compared with conventional linings using integrally cast sleeves of gray iron.

A coating for components of internal combustion engines, in particular for cylinder and/or piston surfaces can have the following composition in accordance with the invention, the content of the respective substance in the coating is given as a mass fraction: chromium 1 to 30%, preferably 11%, solid material content such as aluminum oxide, zircon oxide, chromium carbide, boron carbide 0 to 50% total content, preferably 25%, solid lubricant such as molybdenum disulfide, tungsten sulfide, iron oxide 0 to 30%, preferably 10%.

The honing structure inside the cylinder running surface is, for example, performed as follows R. pk<0.1, R.k.<0.4, R. vk. from the porosity of the cut layer.

Low fuel consumption is achieved by a rapid transition to hydrodynamic friction because of low cylinder surface roughness. At the same time, adequate oil retention volume is provided from the porosity of the coating. Additional friction reduction is achieved by embedded solid lubricant. Corrosion resistance is achieved by balanced chromium content, wear resistance by balanced content of hard phases. A cost advantage exists compared with a powder-based method.

Low fleet consumption, increased power density of the internal combustion engines from high wear resistance of the cylinder bore, corrosion resistance at high return flow rates of cooled exhaust gas recirculation (EGR) required after Euro 6, even after engine cold start phases without expensive temperature-controlled EGR control.

At high combustion temperatures (above 1,800° C.), increased levels of environmentally harmful nitrous oxides are created. To reduce said oxides, combustion temperate must be lowered during exhaust gas recirculation (EGR). The creation of NOx in gasoline or diesel internal combustion engine is reduced with the aid of exhaust gas recirculation. To achieve this, in external exhaust gas recirculation some of the exhaust gas is taken via a pipe back to the induction side and there mixed with the fresh gas. An exhaust gas recirculation valve mounted outside the engine controls this process.

Depending on the system, some exhaust gas is sucked in again through the open exhaust valve (internal exhaust gas recirculation). Recirculating oxygen-poor exhaust gas containing carbon dioxide displaces fresh air in the intake manifold and lowers the oxygen content of the fresh gases, which reduces combustion speed. The greater heat capacity of the exhaust gas compared with fresh air drops combustion temperature because the carbon dioxide present absorbs part of the combustion heat. One could say that the exhaust gas does not participate in combustion but it must be heated. Consequently, combustion temperature falls.

By reducing the oxygen content and dropping combustion temperature, combustion temperature and consequently exhaust gas temperature are reduced from the usual 700° C. to 400° C. By dropping combustion temperature, a large part of the nitrous oxides is not even generated.

Exhaust gas recirculation takes place only at part load because the engine is running particularly lean. During a cold start, warm up and at wide-open throttle, exhaust gas recirculation is no longer meaningful. Exhaust gas recirculation sometimes takes place at idle as well, but only for a limited time. Exhaust gas recirculation at wide-open throttle would result in the creation of black smoke and a loss of performance because of the lack of air.

Dropping combustion temperature always results in reducing NOx content in the exhaust gas.

The coatings 1, 2 and 3 under the invention for internal combustion engine components, in particular for cylinder and/or piston surfaces are compared in the following table. All the coatings result in a reduction of friction between cylinder wall and piston. Coatings 2 and 3 additionally increase corrosion resistance for internal combustion engine components.

A diamond chrome coating (GDC®) has extremely low wear rates, with excellent friction/sliding properties and very precise, durable formability malleability.

Coatings for Components of Internal Combustion Engines

| Designation | Coating 1 | | Coating 2 | | Coating 3 | |
|---|---|---|---|---|---|---|
| Effect | Low friction | | Low friction and | | Low friction and | |
| | | | corrosion resistance | | corrosion resistance 2 | |
| Element/mass | Fe, C 0.8% | | Cr 9% | | Cr 17% | |
| fraction | | | | | | |
| Note | | | Carbide | | precipitation | |
| Wet liner | <- | | <- | | <- | |
| Commercial vehicle | <- | | <- | | <- | |
| Piston ring coating | GDC, PVD, DLC | | PVD, DLC | | DLC | |
| Pore surface [μm²] | 500- | >1,000 | 500- | >1,000 | 500- | >1,000 |
| | 1,000 | | 1,000 | | 1,000 | |
| Avg pore volume | 1,500- | 6,000- | 1,500- | 10,000- | 500- | 2,000- |
| [μm³] | 5,000 | 40,000 | 5,000 | 40,000 | 10,000 | 40,000 |

| | | | |
|---|---|---|---|
| Smooth honing | <- | <- | <- |
| Spk (reduced | <0.10 | <0.10 | <0.10 |
| peak roughness) | | | |
| Sk (reduced | <−0.20 | <0.20 | <0.20 |
| base roughness) | | | |
| Wire filler | | | |

GDC ®—Diamond chrome coating
PVD—Physical vapor deposition
DLC—Diamond-like carbon

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A coating composition for components of internal combustion engines comprising:
chromium present in a mass fraction between 1 and 30%;
iron present in a mass fraction between 0 and 50%;
compounds composed of at least one of carbides, oxides or carbide/oxide mixtures present in a mass fraction between 0 and 50%; and
a solid lubricant present in a mass fraction between 0 and 30%.

2. The coating of claim 1, wherein the oxides are aluminum oxide and/or zirconium oxide.

3. The coating of claim 1, wherein the carbides are chromium carbide and/or boron carbide.

4. The coating of claim 1, wherein the solid lubricant is molybdenum dioxide, tungsten dioxide and/or iron oxide.

5. The coating of claim 1 wherein the carbides are chromium carbide and/or boron carbide, carbides are chromium carbide and/or boron carbide, solid lubricant is molybdenum dioxide, tungsten dioxide and/or iron oxide and wherein the composition is applied to at least one surface defined on a cylinder and/or a piston and. wherein the applied coating contains pores.

6. The coating of claim 5, wherein the pores have a pore surface greater than 1,000 μm².

7. The coating of claim 5, wherein the pores have an average pore volume between 1,000 and 60,000 μm³.

8. The coating of claim 5, wherein the coating has a peak roughness less than 0.30.

9. The coating of claim 8, wherein the coating has a core roughness less than 0.40.

10. A process for imparting a corrosion- and wear-resistant cylinder surface and/or surface of a piston for internal combustion engines for low friction comprising the step of wire spraying a material having a chromium between 1% to 30% with the balance being other solids onto the surface of the part in question.

11. The process of claim 10 wherein the chromium is present in an amount between 9% and 13%.

12. The process of claim 10 wherein the chromium is present as 11% of the composition.

13. The process of claim 10 wherein the composition further comprises iron present in a mass fraction between 0 and 50%; at least one of carbides, oxides or carbide/oxide mixtures present in a mass fraction between 0 and 50%; and a solid lubricant present in a mass fraction between 0 and 30%.

14. A coating composition for components of internal combustion engines comprising:
chromium present in a mass fraction between 5 and 20%;
iron present in a mass fraction between 15 and 35%;
compounds composed of at least one of carbides, oxides or carbide/oxide mixtures present in a mass fraction between 15 and 35%, wherein the carbides are chromium carbide and/or boron carbide and the oxides are aluminum oxide and/or zirconium oxide; and
a solid lubricant present in a mass fraction between 5 and 15%, wherein the solid lubricant is molybdenum dioxide, tungsten dioxide and/or iron oxide;
wherein the coating is present on at least one of a cylinder or a piston and wherein the coating has pores.

15. The coating of claim 15, wherein the pores have a pore surface greater than 1,000 μm², an average pore volume between 1,000 and 60,000 μm³, a peak roughness less than 0.30, and a core roughness less than 0.40.

16. The coating of claim 1, wherein the pores have a pore surface between 250 and 1,500 μm², an average pore volume between 2,000 and 40,000 μm³, a peak roughness less than 0.30, and a core roughness less than 0.30.
